(19) United States
(12) Patent Application Publication
(10) Pub. No.: US 2013/0278238 A1
(43) Pub. Date: Oct. 24, 2013

(54) ELECTRONIC DEVICE

(71) Applicant: DONG-LIANG REN, Shenzhen City (CN)

(72) Inventor: DONG-LIANG REN, Shenzhen City (CN)

(21) Appl. No.: 13/664,436

(22) Filed: Oct. 31, 2012

(30) Foreign Application Priority Data
Apr. 24, 2012 (CN) 201210121552.9

(51) Int. Cl. G05F 3/02

(52) U.S. Cl. 323/311

(57) ABSTRACT

An electronic device receiving a voltage from a power supply comprises a load, a control module, a switching module, and a protection module. The control module generates a first control signal. The protection module transmits the first control signal to the switching module. The switching module establishes an electrical connection between the power supply and the load in response to the first control signal. The load is powered by the power supply when the electrical connection between the power supply and the load is established. The protection module connected between the control module and the switching module prevents a reverse current or a reverse voltage supplied by the power supply from being transmitted to the control module.

### BACKGROUND

1. Technical Field

The present disclosure relates to electronic devices, particularly to an electronic device with a reverse current or a reverse voltage protection function.

2. Description of Related Art

Electronic device generally includes a power supply, a load, a switching module and a control chip. The control chip control the switching module to be turned on or turned off. When the switching module is turned on, an electrical connection between the power supply and the load is established, and the load is powered by the power supply. When the switching module is turned off, the electrical connection between the power supply and the load is cut off, and the power supply stops powering the load. However, a reverse current flows from the power supply to the control chip when the electrical connection between the power supply and the load is established, thus the control chip may be destroyed or damaged by the reverse current.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one”.

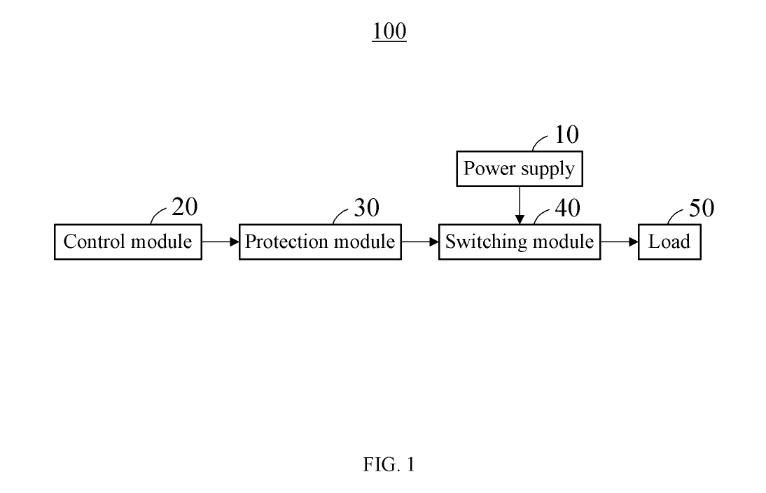

FIG. 1 shows an electronic device 100 of one embodiment of the present disclosure. The electronic device 100 includes a power supply 10, a control module 20, a protection module 30, a switching module 40, and a load 50. In the embodiment, the electronic device 100 can be a computer, or TV, for example.

The power supply 10 provides a voltage.

The control module 20 is electrically connected to the protection module 30. The control module 20 generates a first control signal or a second control signal. In the embodiment, the control module 20 is a chip; the first control signal is a logic low level signal and the second control signal is a logic high level signal.

The protection module 30 is connected between the control module 20 and the switching module 40. The protection module 30 is used for transmitting the first control signal or the second control signal to the switching module 40 and preventing a reverse current or a reverse voltage supplied by the power supply 10 to be provided to the control module 20.

The switching module 40 establishes the electrical connection between the power supply 10 and the load 50 in response to the first control signal, and disconnects the electrical connection between the power supply 10 and the load 50 in response to the second control signal.

The load 50 is being powered on by the voltage of the power supply 10 to execute the corresponding function when the switching module 40 establishes the electrical connection between the power supply 10 and the load 50, such as playing music function, playing video function, for example.

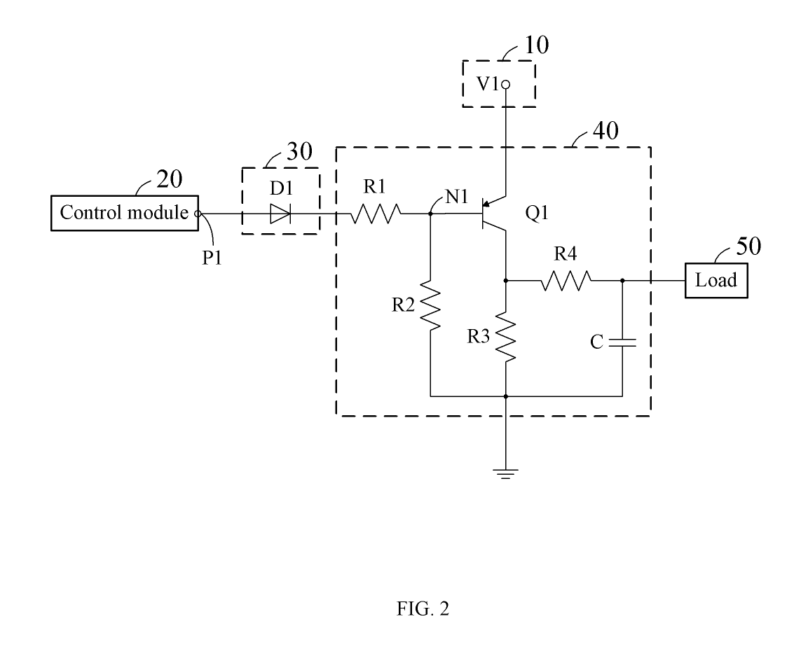

FIG. 2 shows the power supply 10 included a power terminal V1 for providing voltage. The control module 20 includes a first pin P1 for outputting the first control signal or the second control signal.

The protection module 30 includes a diode D1. An anode of the diode D1 is electrically connected to the first pin P1. A cathode of the diode D1 is electrically connected to the switching module 40.

The switching module 40 includes a transistor Q1, a first resistor R1, a second resistor R2, a third resistor R3, a fourth resistor R4, a first node N1, and a capacitor C. A base of the transistor Q1 is electrically connected to the cathode of the diode D1 through the first node N1 and the first resistor R1 in that order. An emitter of the transistor Q1 is electrically connected to the power terminal V1. A collector of the transistor Q1 is grounded through the third resistor R3. An end of the second resistor R2 is electrically connected to the first node N1, and the other end of the second resistor R2 is grounded. An end of the fourth resistor R4 is electrically connected to the collector of the transistor Q1, and the other end of the fourth resistor R4 is electrically connected to the load 50. An end of the capacitor C1 is connected to the load 50, and the other end of the capacitor C1 is grounded. In the embodiment, the transistor Q1 is a pnp type bipolar junction transistor.

When the first pin P1 outputs a first control signal, the difference in voltage between the anode and the cathode of the diode D1 is smaller than 0.3V, the diode D1 is turned off. The voltage at the first node N1 is almost 0V. The difference in voltage between the base and the emitter of the transistor Q1 is smaller than 0V, the transistor Q1 is turned on and the electrical connection between the power terminal V1 and the load 50 is established. The load 50 is powered on by the voltage of the power terminal V1. The reverse current or a reverse voltage from the power terminal V1 to the first pin P1 is stopped by the diode D1 for preventing the reverse current from flowing into the control module 20.

When the first pin P1 outputs a second control signal, the difference in voltage between the anode and the cathode of the diode D1 is larger than 0.3V, the diode D1 is turned on. The voltage at the first node N1 is at a high level. The difference in voltage between the base and the emitter of the transistor Q1 is equal to or greater than 0V, the transistor Q1 is turned off and the electrical connection between the power terminal V1 and the load 50 is cut off. The load 50 is powered off.

As described, the protection module 30 is used for preventing the reverse current from flowing into the control module 20 when the switching module 40 established the electrical connection between the power supply 10 and the load 50. Therefore, the protection module 30 protects the control module 20 from being destroyed by the reverse current or the reverse voltage.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device receiving a voltage from a power supply, the electronic device comprising:
a load;
a control module adapted to generate a first control signal;
a switching module; and
a protection module connecting the control module and the switching module;
wherein the protection module transmits the first control signal to the switching module, the switching module establishes an electrical connection between the power supply and the load in response to the first control signal, and the load is powered by the power supply; the protection module prevents a reverse current or a reverse voltage supplied by the power supply from being transmitted to the control module.

2. The electronic device of claim 1, wherein the first control signal is a logic low level signal.

3. The electronic device of claim 1, wherein the when the control module further generates a second control signal; the protection module transmits the second control signal to the switching module, and the switching module disconnects the electrical connection between the power supply and the load in response to the second control signal and the power supply stop powering the load.

4. The electronic device of claim 3, wherein the second control signal is a logic high level signal.

5. The electronic device of claim 1, wherein the protection module comprises a diode; an anode of the diode is electrically connected to the control module, and a cathode of the diode is electrically connected to the switching module.

6. The electronic device of claim 1, wherein the switching module comprises a transistor and a first resistor; a base of the transistor is electrically connected to the protection module; an emitter of the transistor is electrically connected to the power supply; a collector of the transistor is grounded through the first resistor; the load is electrically connected to the collector of the transistor.

7. The electronic device of claim 6, wherein the first transistor is a pnp type bipolar junction transistor.

8. The electronic device of claim 6, wherein the switching module further comprises a second resistor and a third resistor, the second resistor is connected between the protection module and the base of the transistor, the third resistor is connected between the collector of the transistor and the load.

9. The electronic device of claim 6, wherein the switching module further comprises a fourth resistor and a capacitor, one end of the fourth resistor is connected to the base of the transistor, and the other end of the fourth resistor is grounded; one end of the capacitor is connected to the load, the other end of the capacitor is grounded.
